(19) United States
(12) Patent Application Publication
(10) Pub. No.: US 2008/0064913 A1
(43) Pub. Date: Mar. 13, 2008

(54) Self-adjusting catalyst for propellant decomposition

(76) Inventors: Arthur J. Fortini, Pasadena, CA (US); Jason R. Babcock, Woodland Hills, CA (US); Matthew J. Wright, La Cresenta, CA (US)

Correspondence Address: CHRISTIE, PARKER & HALE, LLP, PO BOX 7068, PASADENA, CA, 91109-7068, US

(21) Appl. No.: 11/283,575

(22) Filed: Nov. 17, 2005

(51) Int. Cl. B01J 23/58

(52) U.S. Cl. 588/403; 502/328; 502/313; 502/325; 502/302

(57) ABSTRACT

A self-adjusting catalyst—a platinum group metal (PGM) catalyst supported by a second, non-PGM catalyst—and a method of decomposing high-energy chemical propellants such as HAN-based monopropellants, hydrazine, and hydrazine derivatives, and an improved reaction engine, are provided.

### ACKNOWLEDGEMENT OF GOVERNMENT SUPPORT

This invention was made with Government support of Contract No. F04611-03-M-3006, awarded by the United States Air Force (AFRL). The Government has certain rights in the invention.

### FIELD OF THE INVENTION

This invention generally relates to catalysts for the decomposition of high-energy chemical propellants, including single-phase rocket propellants (commonly known as monopropellants), such as hydrazine and hydrazine derivatives, and bipropellants.

### BACKGROUND OF THE INVENTION

Chemical propellants and, in particular, high-energy chemical propellants, are used to power reaction engines in satellites, rockets, and other machines. For example, hydrazine, occasionally used in mixtures containing water or water and hydrazinium nitrate, is a monopropellant for rocket engines, gas generators, auxiliary power units, tank pressurization systems, and other applications. Hydrazine and similar compounds and mixtures can be catalytically decomposed to produce hot, gaseous products, which can then be used to produce thrust, drive a turbine, or otherwise perform work. The advantages of hydrazine include high performance, fast response time when used with a suitable catalyst, and a well-established record of performance. Furthermore, the decomposition of hydrazine takes place at moderate temperatures (<1000° C.), and the decomposition products (N₂, H₂, and NH₃) are non-oxidizing. This allows one to use steel and/or nickel-based alloys for the combustion chamber, rather than, expensive and exotic materials such as niobium alloys or rhenium.

Despite their widespread use, hydrazine and hydrazine derivatives are not without drawbacks. Hydrazine is classified by the Department of Transportation (DOT) as a flammable liquid, a poison, and a corrosive material. It is also carcinogenic and listed in the Environmental Protection Agency's (EPA's) Toxic Substances Control Act (TSCA) inventory. For these reasons, a significant amount of research has been done with the goal of finding less-hazardous replacements for hydrazine.

The catalyst most frequently used for decomposition of hydrazine and its derivatives is Shell-405, which utilizes highly dispersed iridium on a high-surface area, aluminum oxide support, as described in U.S. Pat. No. 4,124,538 (the entire contents of which are incorporated by reference herein). In a typical satellite propulsion application, the catalyst bed is heated to approximately 200° C. prior to introducing the propellant. Failure to preheat the catalyst decreases the life of the catalyst bed by increasing the severity of the thermal shock experienced by the catalyst due to the large amount of heat released by the propellant decomposition. The result of repeated thermal-shock cycles is mechanical attrition of the catalyst granules and loss of fines from the bed. Despite the undesirable effects of “cold starts,” the catalyst is capable of decomposing hydrazine at temperatures as low as 2° C., the freezing point of hydrazine. For hydrazine blends with lower freezing points, the catalyst still has sufficient activity to allow cold starts. This capability is useful in satellite applications as it makes the system usable in the event of failure of the catalyst bed heater.

In the search for a less-hazardous substitute for hydrazine and hydrazine derivatives, the U.S. Air Force, NASA, and others have identified single-phase mixtures of hydroxylammonium nitrate (HAN), a miscible fuel, and water as candidate replacements. HAN is an oxygen-rich compound that is classified as a molten salt. Several fuel components have been investigated including hydroxyethylhydrazinium nitrate (HEHN), diethylhydroxylammonium nitrate (DEHAN), triethanolamine nitrate (TEAN), methanol (MeOH), glycine, and others. The oxidizer-to-fuel ratio for these propellants can be varied from fuel-rich to stoichiometric to oxidizer-rich.

Compared to hydrazine, HAN is far less toxic. The LD₅₀ (rat) value for a HAN/TEAN/water mixture known as XM-46 is reported as 718 mg/kg. For comparison the LD₅₀ (rat) value is 60 mg/kg for hydrazine and 192 mg/kg for caffeine. XM-46 is not listed as a human carcinogen, and in animal testing it tested negative as a carcinogen and negative as a mutagen. The low toxicity of HAN-based monopropellants makes them very attractive compared to hydrazine, both in terms of protective-equipment requirements and post-spill procedures. Waterproof gloves and an apron are considered adequate personal protective equipment (PPE), and the effects of a ground spill are similar to that of excess nitrate-fertilizer usage.

HAN-based monopropellants typically contain 2-20% water. While adding water decreases the overall thermodynamic performance of the propellant, it increases its stability against accidental ignition and/or detonation. Above a certain threshold, which varies from one propellant formulation to another, the propellant becomes non-detonable, and these are the formulations of greatest interest. Water also makes these propellants more difficult to accidentally ignite, which is advantageous in military applications.

In addition to the greatly reduced toxicity and explosion hazard, HAN-based monopropellants offer increased rocket engine performance relative to hydrazine. Rocket engine performance is most commonly expressed in terms of the specific impulse (Iₛₚ), which is the thrust provided by the engine expressed in pounds of force (lb_{f}), divided by the propellant flow rate, which is expressed in pounds per second (lbₘ/sec.). The proper units for Iₛₚare lb_{f}·sec/lbₘ, but the generally accepted practice in the industry is to abbreviate it as seconds.

For hydrazine, the theoretical Iₛₚ is 234 sec. if one assumes a chamber pressure of 1000 psia and a 40:1 expansion ratio. Using similar assumptions, a formulation containing 54.1% HAN, 34.9% HEHN, and 11% water has an Iₛₚ of 272 sec. Propellants using these ingredients are typically referred to as AF-315, and a letter suffix is added to the designation to indicate the ingredient proportions. For example, the above propellant formulation is referred to as AF-315I. If the mass ratios are changed to 44.5% HAN, 44.5% HEHN, 11% water, the designation is AF-315E, and the Iₛₚ is 263 sec.

Another performance parameter that is often considered is that of density-Iₛₚ, which is the product of the propellant density and the specific impulse, and it has the abbreviated units of g·sec/cm³. The theoretical density-Iₛₚ of hydrazine is 234 g·sec/cm³, and that of the above AF-315I blend is 403 g·sec/cm³. This is a 16% increase in Iₛₚ and a 72% increase in density Iₛₚ.

All of these features combine to make HAN-based monopropellants attractive as replacements for hydrazine in virtually all of hydrazine's current applications. These applications include monopropellant and bipropellant thrusters, auxiliary power units, emergency power units, tank pressurization systems, and gas generators.

HAN-based monopropellants are not without drawbacks. One of the drawbacks is that these propellants are difficult to ignite. While this makes them inherently safer, it also makes them difficult to use. Testing of these propellants with highly dispersed platinum-group metal (PGM) catalysts, such as Shell-405, indicates that PGMs are suitable catalysts for initiating the highly-exothermic HAN-based propellant decomposition reaction, but the catalyst must be heated to approximately 200° C. for the reaction to occur at an acceptable rate.

HAN-based monopropellants also have extremely high flame temperatures, which can reach 2084° C. for AF-315I and 2358° C. for AF-315A. For a catalyst to operate reliably after hours of accumulated operation, the catalytically-active material must maintain a large surface area. The challenge is that most materials will sinter rapidly at these temperatures and lose surface area. With Shell-405, for example, the gamma-alumina support begins to convert to alpha alumina at approximately 1100° C. This conversion results in a rapid loss of surface area. Testing of Shell-405 with AF-315I shows that this renders the catalyst unsuitable for further use after only 5-10 seconds of operation.

Various attempts have been made to develop a monopropellant catalyst/support system that is thermally stable enough to handle these extreme environments. In one effort, researchers impregnated iridium into alumina doped with various secondary metal oxide phases. The material exhibited catalytic behavior (i.e. decomposition of a HAN/HEHN/H₂O mixture below the material's thermal decomposition temperature). However, the use of doped alumina does not improve the thermal stability over Shell 405 appreciably. In another effort, the same research group doped alumina supports in aerogel and xerogel forms. However, the long-term thermal stability of such supports is questionable.

A variety of single-metal ceramic oxide, carbide, nitride, and boride phases have been evaluated as supports for Ir catalysts, with moderate success. However, surface areas reported for these supports were <1 m²/g and, therefore, they are likely not attractive catalysts for HAN-based monopropellant decomposition. The most promising system reported to date involved the use of various metal hexaaluminate supports, e.g., barium hexaaluminate (BaO·6Al₂O₃), with PGM catalysts. While barium hexaaluminate is generally considered to have good resistance to sintering, the data showed that 5 hours at 1300° C. yields a surface area of only 18.5 m²/g, and 5 hours at 1600° C. reduces it further to 11 m²/g. With a melting point of only 1915° C., barium hexaaluminate is clearly unsuitable for use with anything but the lower-performing propellant blends, and even those will likely cause rapid sintering and loss of surface area.

Yet another drawback of HAN-based propellants is their corrosive nature. Under ambient conditions they contain approximately 2% nitric acid (HNO₃). But because the oxidizer (HAN), and frequently the fuel component as well, contain nitrate ions (NO₃⁻), the corrosive nature of these propellants is much greater than that of a 2% HNO₃ solution. The weight percent of NO₃⁻ in AF-315I, for example, is 51%.

The corrosion issue is aggravated by the fact that one of the initial decomposition products of NO₃⁻ is NO₂, which is extremely corrosive as well. The reduction potential of NO₃⁻ is 0.91 V, whereas that of NO₂ is 0.98 V. This implies that NO₂ is actually more corrosive than NO₃⁻.

It has been experimentally verified that N₂O₄, which is the dimer of NO₂, rapidly attacks iridium at temperatures as low as 500° C. Consequently, rapid loss of iridium in the catalyst bed will take place in areas where the temperature and oxidizing potential of the chemical species are sufficiently high. This will typically be a zone that begins downstream of the bed inlet and which extends some distance downstream. Surrounding this zone, where the rate of iridium loss is greatest, will be transition zones where loss of the iridium is also taking place, but at a reduced rate.

After a period of operation, the iridium content of the bed will take on a profile where it is high near the inlet, gradually drops down to a minimum value, and then gradually increases further downstream. As additional propellant is passed through the bed, the iridium content in the affected areas will continue to drop. If no other suitable catalyst is present in the area of iridium depletion, combustion instabilities and pressure spikes will occur. Ultimately, the loss of iridium will lead to pooling of propellant, detonation, and damage to or loss of system hardware.

There is a continuing and long-felt need for high-performance catalysts capable of surviving the high-temperature and corrosive reaction environments encountered in high-energy chemical propellant thrusters.

### SUMMARY OF THE INVENTION

The present invention provides improved catalysts and methods for decomposing high-energy chemical propellants, including HAN-based monopropellants, hydrazine, hydrazine derivatives, bipropellants, and the like. Monopropellant and bipropellant thrusters, auxiliary power units (APUs), emergency power units (EPUs), tank pressurization systems, gas generators, and similar reaction engines will benefit from the new invention.

According to one aspect of the invention, a propellant decomposition catalyst comprises a platinum group metal catalyst supported by a second catalyst selected from the group consisting of barium oxide, metal chromites, metal hafnates, metal zirconates other than calcium zirconate, and hydrates and mixtures thereof. The combination of a PGM and a second catalyst (sometimes referred to as a catalytically active support material)—both of which catalyze the decomposition of high-energy chemical propellants—ensures that the catalyst continues to function as the PGM is eroded by high temperatures and chemical attack. That is, although the propellant decomposition reaction causes localized loss of the PGM, and development of a zone containing insufficient PGM to sustain the reaction, the combustion reaction is sustained, as the second catalyst is exposed. The combination of PGM catalyst and second catalyst is said to be “self-adjusting;” it “adjusts” to the depletion of PGM and continues to catalyze the thrust-generating decomposition reaction.

In a second aspect of the invention, a method of sustaining propellant decomposition is provided, and comprises passing a propellant having an adiabatic flame temperature, T₁, over a platinum group metal catalyst supported by a second catalyst; and sustaining propellant decomposition as the platinum group metal catalyst is eroded away during use by passing a propellant over the second catalyst; wherein the second catalyst has a melting point higher than T₁, and is selected from the group consisting of metal chromites, metal hafnates, metal zirconates other than calcium zirconate, barium oxide, and hydrates and mixtures thereof. In some embodiments, however, the PGM is optional. Therefore, the method can be described more generally as a method of sustaining propellant decomposition, comprising: passing a propellant having an adiabatic flame temperature, T₁, over a catalyst comprising (a) a catalytic material having a melting point higher than T₁, selected from the group consisting of metal chromites, metal hafnates, and hydrates and mixtures thereof, or (b) a platinum group metal catalyst supported by a second catalyst selected from the group consisting of barium oxide, metal chromites, metal hafnates, metal zirconates other than calcium zirconate, and hydrates and mixtures thereof.

In another aspect of the invention, an improved reaction engine is provided, and comprises a thrust chamber (or a similar reaction chamber) provided with a catalyst bed comprising (a) a catalytic material selected from the group consisting of metal chromites, metal hafnates, and hydrates and mixtures thereof, or (b) a platinum group metal catalyst supported by a second catalyst selected from the group consisting of barium oxide, metal chromites, metal hafnates, metal zirconates other than calcium zirconate, and hydrates and mixtures thereof. Where a PGM catalyst is supported on a second catalyst, the catalyst combination is self-adjusting, and therefore unique from a traditional 2-stage or multi-stage catalyst bed. The propellant decomposition environment determines where PGM is lost and how fast it is removed. In general, it is only removed from those areas where it is kinetically or thermodynamically unstable. In all other areas the PGM remains in the bed and continues to function as a catalyst. This results in the maximum amount of PGM being present, and hence maximum propellant decomposition efficiency being achieved, at any given time in the life of the catalyst bed.

Advantageously, the second catalyst is itself capable of sustaining a propellant decomposition reaction, even without a PGM catalyst. This makes it possible to provide a number of different catalyst beds and thrust chamber configurations. For example, in one embodiment, an upstream bed contains a PGM catalyst supported on a second catalyst selected from the inorganic materials identified above. A second bed contains only the second catalyst, without a PGM. Other configurations also fall within the scope of the invention.

### BRIEF DESCRIPTION OF THE DRAWINGS

These and other features and advantages of the invention will become better understood when considered in conjunction with the following detailed description and by making reference to the appended drawings, wherein:

FIG. 1 is a schematic illustration of a monopropellant thruster containing a decomposition propellant according to one embodiment of the invention;

FIG. 2 is a schematic illustration of a Pino Tester used to test selected catalysts prepared in accordance with the present invention; and

FIG. 3 is a plot of Two-Stage Pino Test Results for catalysts prepared in accordance with the present invention.

### DETAILED DESCRIPTION OF THE INVENTION

According to a first aspect of the invention, a propellant decomposition catalyst is provided and comprises a platinum group metal (PGM) catalyst supported by a second catalyst selected from the group consisting of barium oxide, metal chromites, metal hafnates, metal zirconates other than calcium zirconate, and hydrates and mixtures thereof. Advantageously, the propellant decomposition catalyst can be loaded into a monopropellant thrust chamber or other reaction engine, for example, as a bed of catalyst powder, granules, or a porous monolith.

The PGM catalyst functions as the primary catalyst for propellant decomposition. However, due to the corrosive, high-temperature environment encountered in high-energy chemical propellant thruster chambers, the PGM eventually erodes and is lost during use, at least locally, downstream of the thruster chamber inlet. However, because the underlying support material (the “second catalyst”) is itself catalytic, it sustains the propellant decomposition reaction, and extends the operable life of the thruster. As a whole, the propellant decomposition catalyst is “self-adjusting;” it responds to the corrosive, high-temperature environment of a thrust chamber and sustains the propellant decomposition reaction (which is sometimes referred to as “combustion,” though O₂ is typically not present), even as the PGM is depleted during use.

PGMs include platinum, palladium, iridium, rhodium, ruthenium, and osmium. As used herein, the term “platinum group metal catalyst” includes any of the individual metals, as well as mixtures and alloys thereof. Iridium is most preferred, followed by platinum and ruthenium.

The second catalyst, which supports the PGM, is itself capable of sustaining a high-energy chemical propellant decomposition reaction. Particularly useful are high melting point, catalytically active materials that can tolerate the combustion environment produced by high-energy chemical propellants. Because of their inherent oxidation resistance, certain oxides and oxide-like compounds are well suited to this role. In general, materials considered to be suitable for use as a second catalyst for high-energy chemical propellant decomposition include barium oxide, perovskites, materials having a perovskite-like structure, polymorphs of such materials, and hydrates and mixtures thereof. Nonlimiting specific examples include metal chromites, such as yttrium chromite and lanthanide chromites (e.g., lanthanum chromite, ytterbium chromite, erbium chromite, and neodymium chromite); metal hafnates, such as barium hafnate; and zirconates, such as barium zirconate. Calcium zirconate, however, did not perform well in tests and is not preferred. Also included are hydrates and mixtures of any of the aforementioned materials, as well as various polymorphs of the materials.

In some embodiments of the invention, the propellant decomposition catalyst includes a source of, and/or a sink for, oxygen radicals or ions. A nonlimiting example is cerium oxide (ceria), a nonstoichiometric compound. In cerium oxide, cerium exhibits two oxidation states, Ce³⁺ and Ce⁴⁺. Without being bound by theory, it is believed that cerium oxide stores and releases oxygen radicals or ions through the transformation of cerium from the +4 to the +3 oxidation state, and vice versa.

A rough ranking of selected catalytic materials useful for decomposition of a high-energy chemical propellant is presented in Table 1. Barium hexaaluminate and lanthanum hexaaluminate are included for comparison. Many of these materials were tested with AF-315 and shown to have catalytic activity, i.e., the ability to catalyze its decomposition. The relative rankings may change, depending on the choice of propellant.

TABLE 1
Relative Activity of Catalytic Support Materials
(Ranked by Most to Least Active)

| Material | Formula | Tₘₑₗₜ (° C.) |
|---|---|---|
| Yttrium chromite | YCrO₃ | 2287 |
| Lanthanum chromite | LaCrO₃ | 2427 |
| Barium hafnate | BaHfO₃ | 2620 |
| Barium zirconate | BaZrO₃ | 2627 |
| Barium oxide | BaO | 1918 |
| Neodymium chromite | NdCrO₃ | 2327 |
| Ytterbium chromite | YbCrO₃ | 2127 |
| Barium hexaaluminate | BaO•6Al₂O₃ | 1915 |
| Lanthanum | La₂O₃•11Al₂O₃ | 1848 |
| hexaaluminate | | |

Mixtures of these materials with cerium oxide (CeO₂; Tₘₑₗₜ=2397° C.) are also catalytically active.

Although the dimensions and morphology of the catalytic material may be dictated by the choice of reaction engine and/or propellant with which the catalyst is to be used, in general, the catalytic material is provided as a powder, porous granules, or a porous monolith, with a surface area sufficiently high to sustain a high-energy chemical propellant decomposition reaction. In one embodiment of the invention, the catalytic material has a surface area of about 0.1 to 1000 m²/g, about 0.1 to 105 m²/g, about 3 to 105 m²/g, or about 10 to 105 m²/g, prior to supporting (e.g., being impregnated with) the platinum group metal catalyst. In general, catalytic activity increase with surface area.

For a powder, typical particle size is about 50 μm or less, and the bulk of the surface area (SA) is on the external surface of the particles, rather than internal (pores). Assuming a spherical particle, SA is given by the simple relationship between the radius of the sphere (r) and material density (ρ): SA=3/rρ. Powder beds are considered porous because of the numerous gaps or voids between adjacent particles.

For a porous granule, typical particle size is greater than about 50 μm, and the bulk of the SA is internal; external SA is the same as that of a particle, but internal surface area can be several thousand m²/g, depending on the material and the size and shape of the granule's inner passages (pores). In one embodiment, the catalytic material comprises granules of about 0.1 to 5 mm, preferably about 0.3 to 3 mm, more preferably about 0.6 to 1.41 mm in size. Overall pore volume ranges from about 0.1 to 1.0 cc/g, preferably about 0.2 to 0.6 cc/g, more preferably about 0.3 to 0.5 cc/g, prior to impregnating the granules with a PGM.

For a monolith (i.e., a single unit fabricated to match the desired catalyst bed size), nearly any range of sizes is possible. The nature of the surface area depends upon the type of material that is used to coat the monolithic support and the porosity of the support itself. SAs are generally reported for monoliths in terms of cm²/cm³, that is cm² of surface area per total volume of monolith (cm³).

In general, the catalytic material (“second catalyst”) is coated or otherwise impregnated with an amount of PGM of from about 15 to 30% by weight of the second catalyst.

In one embodiment of the invention, the catalytic material is porous, and the PGM is provided as discrete particles carried within the pores of the second catalyst. A nonlimiting example of a suitable technique for depositing a PGM (i.e., iridium, and ruthenium) on and in a porous carrier (alumina), is provided in the U.S. Pat. No. 4,124,538 (columns 2-8, including Examples I-VI).

In a second aspect of the invention, a method of sustaining propellant decomposition is provided, and comprises passing a propellant having an adiabatic flame temperature, T₁, over a platinum group metal catalyst supported by a second catalyst; and sustaining propellant decomposition as the platinum group metal catalyst is eroded away during use by passing a propellant over the second catalyst; wherein the second catalyst has a melting point higher than T₁, and is selected from the group consisting of metal chromites, metal hafnates, metal zirconates other than calcium zirconate, barium oxide, and hydrates and mixtures thereof. More generally, the method comprises passing a propellant having an adiabatic flame temperature, T₁, over a catalyst comprising (a) a catalytic material having a melting point higher than T₁, selected from the group consisting of metal chromites, metal hafnates, and hydrates and mixtures thereof, or (b) a platinum group metal catalyst supported by a second catalyst selected from the group consisting of barium oxide, metal chromites, metal hafnates, metal zirconates other than calcium zirconate, and hydrates and mixtures thereof.

In general, the propellant comprises either a monopropellant or a bipropellant. The term “monopropellant” typically denotes a chemical substance, or a mixture of substances, typically liquid, that can be decomposed in a reaction engine (e.g., a thrust chamber) to generate hot gases and thrust, without the need for an external oxidizer. In some embodiments, the monopropellant also includes water as a stabilizer. In contrast, a “bipropellant” comprises a fuel and an oxidizer, which are carried separately and brought together in a reaction engine to generate thrust.

Nonlimiting examples of high-energy chemical monopropellants include hydrazine, hydrazine derivatives (e.g., monomethyl hydrazine, unsymmetrical dimethylhydrazine), dimethylaminoethyl azide (DMAZ), mixtures of hydrazinium nitrate (HN) and water, mixtures of hydrazine and hydrazinium nitrate, nitrous oxide, mixtures of nitrous oxide and one or more fuel components (e.g., hydrocarbons), and mixtures of propylene glycol dinitrate, 2-nitrodiphenylamine, and dibutyl sebacate (Otto Fuel II, a distinct-smelling, reddish-orange, oily liquid used by the U.S. Navy as a fuel for torpedoes and other weapon systems).

Also included are high-energy chemical monopropellants containing a generally oxygen-deficient fuel component and an oxidizer. Nonlimiting examples of fuel components for monopropellants include hydroxyethylhydrazinium nitrate (HEHN), diethylhydroxylammonium nitrate (DEHAN), triethanol amine nitrate (TEAN), methanol, glycerol, tris(aminoethyl)amine trinitrate (TRN3), glycine, and mixtures thereof.

Nonlimiting examples of oxidizers for high-energy chemical monopropellants include hydroxylammonium nitrate (HAN), hydrazinium nitrate (HN), hydrazinium nitroformate, ammonium nitrate (AN), 1,4-diazobicyclo-(2,2,2)-octane nitrate (DON), ethylamine nitrate (EAN), ethanolamine nitrate (EOAN), hydroxylamine perchlorate (HAP), isopropylamine nitrate (IPAN), methylamine nitrate (MAN), methyl hydrazine nitrate (N), glycolic materials such as propylene glycol nitrate (PGDN) and triethylene glycol dinitrate (TEGDN), piperidine nitrate (PN), trimethylamine nitrate (TMAN), ammonium dinitrimide, and mixtures thereof. In some cases, the oxidizer has a formula, AB, where A is selected from the group consisting of ammonium (NH₄⁺), hydroxylammonium (NH₃OH⁺), hydrazinium (N₂H₅⁺), piperidinium (C₅H₁₂N⁺), n-alkyl ammonium (H₄₋ₙNRₙ⁺, where n is 1 to 3, and R is C1-C3 alkyl) and quaternary ammonium (NR₄³⁰ , where R is C1-C3 alkyl); and B is selected from the group consisting of nitroformate [C(NO₂)₃⁻], dinitrimide [N(NO₂)₂], and nitrate (NO₃⁻).

Combinations of HAN and a fuel component are particularly useful. Nonlimiting examples include HAN/HEHN, HAN/DEHAN, HAN/TEAN, HAN/AAN, HAN/glycol (e.g., PGDN, TEGDN), HAN/glycerol, HAN/glycine, HAN/methanol (MeOH), and HAN/tris(aminoethyl)amine trinitrate (TRN3). Each blend typically contains 5-20% by weight water as a stabilizer.

The theoretical adiabatic flame temperature (sometimes referred to as the combustion temperature) for stoichiometric HAN/MeOH is 1927° C. For stoichiometric HAN/TRN3, the theoretical combustion temperature is coincidentally also 1927° C.

Table 2 presents theoretical flame temperatures for selected formulations of HAN (oxidizer)/HEHN (fuel component)/water (stabilizer) monopropellants. Temperature calculations assume a pressure of 100-200 psia, and are made using the NASA Glenn code.

TABLE 2
HAN/HEHN/WATER MONOPROPELLANTS

| HAN (% wt) | HEHN (% wt) | Water (% wt) | Flame Temp (° C.) |
|---|---|---|---|
| 63 | 26 | 11 | 1780.6 |
| 58 | 31 | 11 | 1959.9 |
| 56 | 33 | 11 | 2021.8 |
| 54.144 | 34.856 | 11 | 2062.2 |
| 49 | 40 | 11 | 1993.6 |
| 44.5 | 44.5 | 11 | 1884.0 |
| 40 | 49 | 11 | 1772.7 |
| 35 | 54 | 11 | 1649.7 |
| 30 | 59 | 11 | 1528.1 |
| 59.615 | 38.385 | 2 | 2311.1 |

Table 3 presents flame temperatures for a number of different monopropellants, including monomethylhydrazine (MMH), unsymmetrical dimethylhydrazine (UDMH) and various liquid gun propellants, Air Force and Navy liquid propellants, etc., typically denoted by an alpha-numeric code. Three separate formulas for each of XM46 and LP1898 are provided.

TABLE 3
Selected Propellant Compositions (wt %) and Flame Temperatures

| Ingredient | 618A | RK315E | NOS283 | NOS365 | Hydrazine | UDMH | MMH |
|---|---|---|---|---|---|---|---|
| HAN | | 44.5 | 56.9 | 60.7 | | | |
| AN | 23.8 | | | | | | |
| HN | 44.2 | | | | | | |
| Water | 15.0 | 11.0 | 25.0 | 20 | | | |
| HEHN | 17.0 | 44.5 | | | | | |
| IPAN | | | 18.1 | 19.3 | | | |
| Flame | 1797 | 1884 | 1627 | 1806 | 634 | 872 | 920 |
| Temp (° C.) | | | | | | | |

| Ingredient | | XM46 | | | LP1898 | |
|---|---|---|---|---|---|---|
| HAN | 60.79 | 61.875 | 63.75 | 60.80 | 61.875 | 63.750 |
| Water | 20.02 | 17.5 | 15.00 | 20.00 | 17.50 | 15.00 |
| TEAN | 19.19 | 20.625 | 21.250 | | | |
| DEHAN | | | | 19.20 | 20.625 | 21.250 |
| Flame | 1763 | 1833 | 1924 | 1857 | 1941 | 2305 |
| Temp (° C.) | | | | | | |

In another aspect of the invention, an improved reaction engine is provided, and comprises a reaction chamber provided with a catalyst bed comprising (a) a catalytic material selected from the group consisting of metal chromites, metal hafnates, and hydrates and mixtures thereof, or (b) a platinum group metal catalyst supported by a second catalyst selected from the group consisting of barium oxide, metal chromites, metal hafnates, metal zirconates other than calcium zirconate, and hydrates and mixtures thereof. Preferably, the catalytically-active support material (the “second catalyst”) comprises a material listed in Table 1, or a polymorph, hydrate, or mixture thereof, optionally impregnated with a PGM. The reaction engine can be used in rocket engines, gas generators, auxiliary power units, tank pressurization systems, and similar machines.

In one embodiment, a single-stage catalyst bed containing a single propellant decomposition catalyst—e.g., a combination of a PGM catalyst dispersed on and/or in a catalytically active support material as described above—is loaded into a thrust chamber. In this embodiment, the PGM is initially the primary catalyst throughout the entire length of the bed, but exposed areas of the supporting second catalyst can contribute to the overall catalytic activity of the bed. As the PGM is chemically attacked and removed from the bed, the amount of exposed second catalyst increases. Because the support material is catalytically active, it can sustain the combustion reaction in areas where the PGM is partially or completely removed.

In another embodiment, a catalyst as described herein is used as the second stage of a 2-stage catalyst bed. The upstream stage comprises a PGM (e.g., iridium or platinum) dispersed on and/or in a support that cannot tolerate the adiabatic flame temperature of the propellant, but which has a very high surface area, such as gamma alumina. The downstream stage comprises a PGM (e.g., iridium) dispersed on and/or in a catalytically-active, high-temperature-capable support, as described above. In this embodiment, it is desirable that the interface between the two stages is located in an area where the temperature is below the temperature at which gamma alumina loses surface area due to its conversion to alpha alumina.

In yet another embodiment, the invention is again used as the second stage in a 2-stage catalyst bed, but the upstream stage has a higher temperature capability. Lanthanum hexaaluminate and barium hexaaluminate are two examples of supports having moderate-to-low surface area and moderate temperature capability that could be used in the first stage. The downstream stage comprises a PGM (e.g., iridium) dispersed on and/or into a different catalytically-active, high-temperature-capable support (e.g., barium oxide, a perovskite, or a polymorph, hydrate, or mixture thereof). In this embodiment, it is desirable that the interface between the two stages is located in an area where the rate of loss of PGM is minimal. If this is not the case, the support in the upstream section of the bed, which is not catalytically active, will eventually lose enough PGM to cause propellant decomposition instabilities.

The catalyst bed constitutes a structure sufficient to hold the catalyst(s) in place in the reaction chamber. Such structures are well known in the art. In the case where the catalyst comprises a porous monolith, minimal structure may be required, as the monolith can be sized to fit snuggly within the reaction chamber. For catalysts having a granular or powdered form, the catalyst bed has a configuration that is adequate to hold the catalyst in place, and is made of a material sufficiently durable and temperature resistant to survive the propellant decomposition reaction.

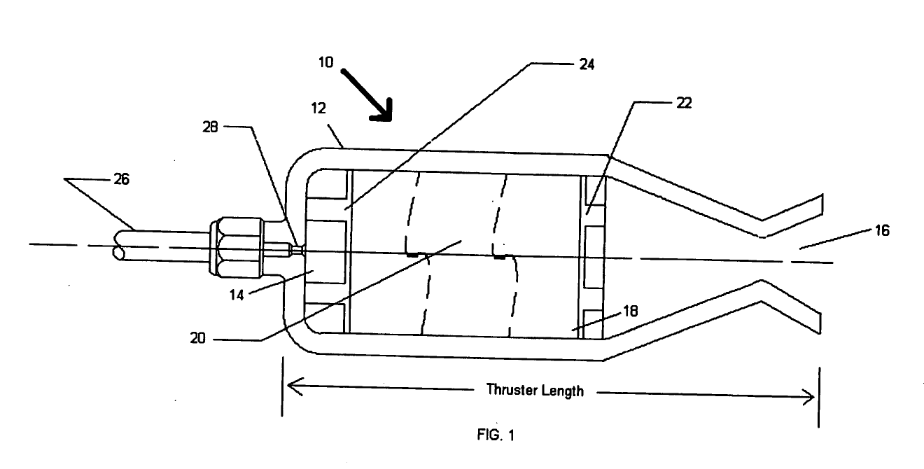

FIG. 1 illustrates an improved reaction engine according to one embodiment of the present invention. In this embodiment, the reaction engine comprises a thruster 10 having a generally cylindrical body 12 that extends from an upstream end 14 (where propellant is introduced) to a downstream end 16 (where exhaust gases are ejected), and defines a thrust chamber (a reaction chamber) 18. A catalyst bed 20 resides in the thrust chamber. A catalytic material impregnated with a PGM, as described herein, is loaded into the catalyst bed and is secured within the thrust chamber by a catalyst bed support plate 22 and a (propellant) distribution plate/injector 24. A monopropellant carried by propellant feed tubing 26 can be introduced into the thruster through a propellant inlet orifice 28. A heater (not shown) is provided proximate the catalyst bed to heat the catalyst to a desired start temperature.

Preferably, the catalytically-active support material and the PGM each have melting points above the adiabatic flame temperature of the propellant with which the thruster is to be used, and it is assumed that the PGM is more effective than the support in initiating the combustion reaction. In addition to being catalytically active, the support has sufficient chemical resistance to survive the propellant decomposition environment for the duration of the application. When a catalyst as described herein is used with a propellant such as AF-315 that will attack the PGM, localized loss of PGM will occur as described above, and a zone containing insufficient PGM to sustain the reaction will develop. But because the loss of PGM in this zone results in exposure of the underlying, catalytically-active support, the propellant decomposition reaction will be sustained.

Because the PGM-depleted zone develops at a location that is downstream of the catalyst bed inlet, the propellant decomposition reaction will have already been initiated on the PGM, and the largest activation-energy barrier will have been overcome. Consequently, a less-active catalyst will be able to sustain the combustion reaction and prevent propellant decomposition instabilities and other deleterious effects. The present invention is therefore distinct from a simple 2-stage or multi-stage catalyst bed that is assembled in a manner that yields two or more well-defined catalyst zones. However, the invention can be used as one or more of the stages in a 2-stage or multi-stage catalyst bed.

Pino Testing

Pino testing is a recognized method of evaluating propellant decomposition catalysts. Pino testing provides two valuable pieces of information: exhaust gas temperature rise rate (the time in milliseconds that it takes the exit gas temperature to rise a specified amount over the initial starting temperature) and overall temperature achieved. In general, the hotter the exhaust, the better the performance. A higher exit gas temperature indicates better catalytic performance, i.e., more complete decomposition of the propellant, and greater thrust. (The relationship between exhaust temperature, T, and specific impulse, Iₛₚ, is given by

$$Isp = \sqrt{\frac{2 kRT}{{g}_{c} ( k - 1 ) M}}$$

where k is the specific heat ratio of the exhaust-gas mixture, R is the gas constant, T is the gas temperature, g_{c} is the gravitational constant used to convert from weight to mass, and M is the mean molecular weight of the exhaust gas.) Similarly, the shorter the exit gas temperature rise rate, the better the performance. A short rise rate indicates faster ignition of the propellant.

Conventional Pino testing involves placing a catalyst sample into a holder, suddenly immersing it into a pool of propellant, and measuring the temperature-versus-time response of a thermocouple in the sample holder. While the temperature of the catalyst and propellant can be independently set prior to immersion, the most common procedure employs a heated catalyst sample and ambient-temperature propellant.

For the catalysts described herein, measuring the ignition-response time of the PGM-coated support is not sufficient. Additional testing must be done to quantify the performance of the support itself because, after some period of time, the support will be exposed and its catalytic performance will become important. But, because the support will be catalyzing a reaction that is already under way—it will have been initiated by the PGM in the upstream section of the bed—simply quantifying its activity with unreacted propellant is not an appropriate test. A more relevant test involves measuring the catalytic activity of the support on the products of incomplete combustion.

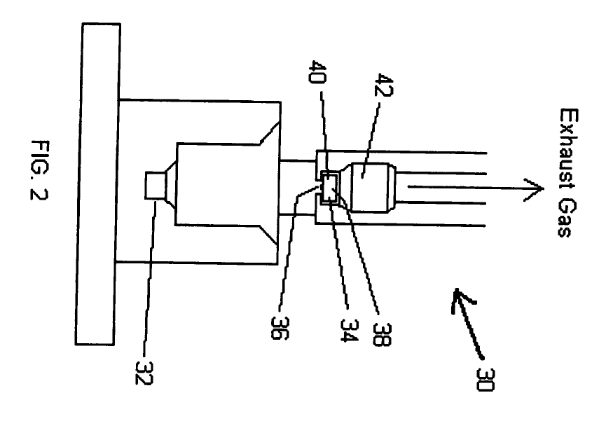

To perform this type of test, a modified Pino test set-up is used, as shown in FIG. 2. The Pino Tester 30 includes a propellant cup 32, a catalyst bed or holder 34 having an “upstream” portion 36 near the bottom of the holder and a “downstream” portion 38 near the bottom of the holder, a bottom thermocouple 40, and a top thermocouple 42. Test samples can be preheated with a heater (not shown). Exhaust gases exit from the top of the Pino Tester.

Iridium-coated material is placed in the bottom (upstream) portion 36 of the sample holder, catalytically active support material is placed in the downstream portion 38, and thermocouples are placed in both locations. Thus, when the sample is plunged into the propellant, the propellant will first encounter the iridium-coated material, and the reaction will begin. The fluid will then be forced to flow into the downstream portion of the catalyst bed, where the catalytically-active support will sustain the decomposition reaction.

Because the unimolecular and bimolecular reactions taking place in the downstream portion of the bed are different, and because the reactants will consist of hot, reactive intermediates, it is quite conceivable that the support will be a better catalyst than iridium. To determine if this is the case, three different test scenarios can be utilized. The first is as described above, where the downstream portion of the catalyst bed consists of the uncoated, catalytically-active support material. An alternative arrangement is to use the same iridium-coated catalyst upstream, with an inert support, such as ZrO₂, used in the downstream portion of the bed (experiment control). The use of an inert support downstream will permit a comparison with the first experiment thus allowing quantification (qualification) of the catalytic performance of the support. Still another alternative is to use iridium-coated catalyst throughout the entire bed, and it too will act as a baseline (e.g., an all LCH-227 test). By comparing the results of the third experiment to that of the first, the activity of the iridium can be compared to that of the support. If the support is indeed a better catalyst for the intermediate reactions, this comparison will bear that out.

The following are nonlimiting examples of the invention.

### EXAMPLE 1

### General procedure for impregnating a support with a PGM

The following is a representative procedure, using alumina: 0.3766 g IrCl₃ is dissolved in a minimal amount of ethanol (ca. 10 ml), and 0.5057 g of alumina spheres are added to the solution. The mixture is allowed to stand for 40 h, during which time the solvent is slowly evaporated. The coated alumina spheres are dried for 2 h at 220° C. in air, and then calcined for 1 h at 700° C. in an air furnace. 0.6117 g of Ir-coated alumina spheres is recovered (17% Ir by weight).

### EXAMPLE 2

Lanthanum chromite is prepared by adding lanthanum nitrate and chromium nitrate in a 1:1 mole ratio in sufficient water to dissolve the salts. A precipitate is formed by the slow addition of dilute ammonium hydroxide solution. The precipitate is then dried to yield a high-surface-area powder. The powder is then pressed into a wafer, sintered, broken into smaller pieces, and sieved to yield the desired particle size, typically 1-2 mm. The resulting porous granules of catalytically-active lanthanum chromite are then impregnated with an iridium chloride solution and calcined as described in Example 1.

### EXAMPLE 3

Cerium oxide powder is added to a solution of lanthanum nitrate and chromium nitrate, where the mole ratio of cerium to lanthanum to chromium is 10:1:1. Ammonium hydroxide solution is added to the stirred suspension to form a precipitate, which is then calcined in air at 700° C. for 2-4 hours. The resulting mixture of LaCrO₃ and CeO₂ is ground into a powder, pressed into a wafer, sintered, broken into smaller pieces, and sieved to yield the desired particle size, typically 1-2 mm. The resulting porous granules, which consist of catalytically-active cerium oxide and lanthanum chromite in close proximity, are then impregnated with an iridium chloride solution and calcined as described elsewhere.

### EXAMPLE 4

Commercially available barium oxide powder is formed into granules as described in Example 2 and then impregnated with iridium as described in Example 1.

### EXAMPLE 5

Lanthanum nitrate, chromium nitrate and cerium nitrate are dissolved in water, where the molar ratio of cerium to lanthanum to chromium is 60:1:1. Ammonium hydroxide solution is added to the solution to form a precipitate, which is then calcined in air at 700° C. for 2-4 hours. The resulting mixture of LaCrO₃ and CeO₂ is ground into a powder, pressed into a wafer, sintered and broken into smaller pieces, and sieved to yield the desired particle size, typically 1-2 mm.

### EXAMPLES 5-10 AND CONTROL

### Pino Testing

Using the catalyst preparation procedures described above, Examples 5-10 were prepared, without being impregnated with a PGM. To simulate a two-stage catalyst bed, each catalyst was separately evaluated for catalytic activity—the ability to decompose a high-energy chemical propellant—using a modified Pino Tester substantially as shown in FIG. 2. For comparison, a Control (“LCH-227,” a high surface area, iridium-on-gamma-alumina catalyst, produced by Aerojet) was also tested.

The following description is representative of the Pino Test procedure that was used to evaluate the catalysts. 0.5 g of a Control (LCH-227) was placed in the upstream portion of the catalyst holder in order to initiate the reaction. Two thermocouples were used, one in each portion of the bed (holder), and a thermocouple trace recorded data over the lifetime of the test. Each sample was separately tested by placing a given catalyst (0.5 g) in the downstream portion of the bed, adjacent to the upstream 0.5 g charge of the Control. An all-LCH-227 (Control) (1 g) sample was tested for comparison. The catalyst holder was preheated to 300° C. The holder assembly was immersed into the propellant cup to initiate contact with the catalyst. The bottom thermocouple registered the initial temperature response of the catalyst. The top thermocouple registered exhaust gas temperatures. Since exit-gas temperature and rise rate determine performance, the downstream temperature response is the primary variable of interest.

Each catalyst was preheated to about 320° C. in a heating mantle, and then pulled out and allowed to cool to about 300° C., at which time the catalysts and thermocouples were plunged into a pool of room temperature liquid propellant (AF-M315E). The samples' different starting temperatures reflect the materials' different heat capacities. It should also be noted that LCH-227 has a high heat capacity and is not quenched by incoming cold propellant to the extent that the other materials are.

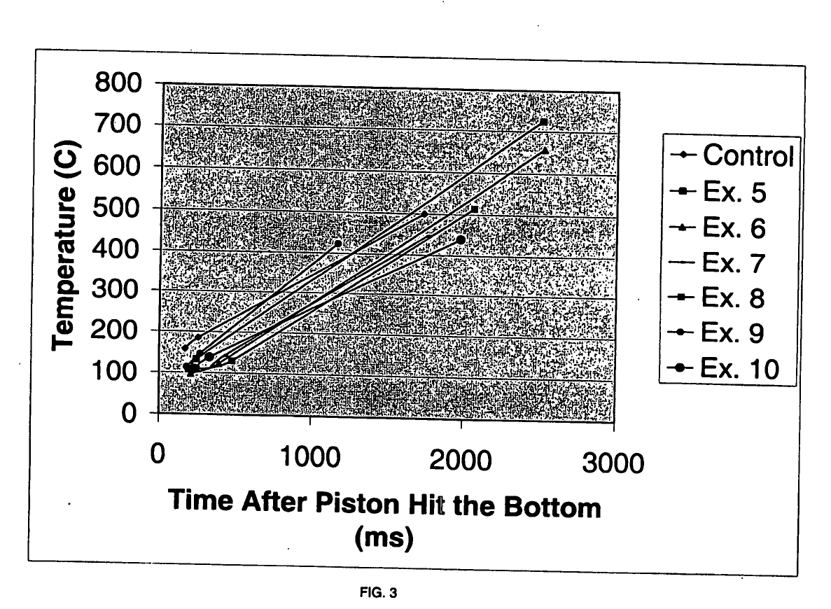

Two-stage Pino test results are presented in Table 4 and FIG. 3. “Exhaust Gas Temperature Rise Rate” (° C./ms) is the heat-up rate of the thermocouple following the initiation of the decomposition of the propellant by the catalyst. “25° C. time” is the time in milliseconds that it takes the exit gas temperature to rise 25° C. over the initial starting temperature.

TABLE 4
Two-Stage Pino Test Results

| | Exhaust Gas | | | | | |
|---|---|---|---|---|---|---|
| | Temp. Rise | Drop | | | | |
| Catalyst | Rate (° C./ms) | time | | Low Temp | 25° C. time | Max. Temp |
| Control | 0.219 | 123 ms | Top | 158 C./172 ms | 185 C./258 ms | 500 C./1733 ms |
| | | | Bottom | 159 C./197 ms | 183 C./332 ms | 632 C./1905 ms |
| Ex. 5 | 0.268 | 135 ms | Top | 107 C./197 ms | 133 C./246 ms | 725 C./2507 ms |
| | | | Bottom | 128 C./233 ms | 152 C./406 ms | 746 C./3600 ms |
| Ex. 6 | 0.242 | 147 ms | Top | 97 C./209 ms | 123 C./393 ms | 657 C./2519 ms |
| | | | Bottom | 112 C./307 ms | 137 C./614 ms | 664 C./3441 ms |
| Ex. 7 | 0.314 | 307 ms | Top | 116 C./344 ms | 142 C./430 ms | 446 C./1757 ms |
| | | | Bottom | 136 C./332 ms | 157 C./492 ms | 418 C./3514 ms |
| Ex. 8 | 0.223 | 135 ms | Top | 108 C./246 ms | 130 C./479 ms | 514 C./2064 ms |
| | | | Bottom | 102 C./283 ms | 127 C./848 ms | 577 C./4129 ms |
| Ex. 9 | 0.188 | 135 ms | Top | 114 C./184 ms | 146 C./270 ms | 423 C./1167 ms |
| | | | Bottom | 139 C./283 ms | 170 C./381 ms | 475 C./3269 ms |
| Ex. 10 | 0.234 | 209 ms | Top | 110 C./233 ms | 138 C./332 ms | 439 C./1978 ms |
| | | | Bottom | 115 C./258 ms | 142 C./430 ms | 514 C./2249 ms |

Control: LCH-227 (iridium-on-gamma-alumina)
Ex. 5: LaCrO₃ on CeO₂, 1:60 molar ratio
Ex. 6: LaCrO₃ on (30% yttria-stabilized zirconia, 70% CeO₂), 1:10 molar ratio
Ex. 7: LaCrO₃ on CeO₂, 1:10 molar ratio
Ex. 8: NdCrO₃ on CeO₂, 1:10 molar ratio
Ex. 9: YCrO₃ on CeO₂, 1:10 molar ratio
Ex. 10 ErCrO₃ on CeO₂, 1:10 molar ratio

### Pino Test Conclusions;

Examples 5 and 9 showed unexpectedly superior performance relative to the Control. In the case of Example 5 (LaCrO₃ on 60 CeO₂), both the rise time and overall temperature realized were better than that of the Control. The Control had an Exhaust Rise Rate of 0.219° C./ms, whereas Example 5's Rise Rate was 0.268° C./ms. The Control reached a maximum exhaust gas temperate of 500° C. in 1733 ms, which gives a ramp rate of 288.8° C./sec. In the same length of time, Example 5 was slightly higher at 525° C., giving a ramp rate of 302.3° C./sec. What is impressive about this catalyst is the overall exhaust gas temperature realized: 725° C., a 45% increase over the Control.

In the case of Example 9 (YCrO₃ on 10 CeO₂), the overall temperature achieved (423° C.) was somewhat less than that of the Control (500° C.). However, in the 1167 ms time it took Example 9 to reach 423° C., the Control was lagging at 375° C. The ramp rates for Example 9 and the Control are 362° C./sec and 289° C./sec, respectively. So the ramp rate of Example 9 bettered the Control by 25%. Furthermore, both Example 5 and Example 9 started at lower initial temperatures than the Control, due to quenching effects of the materials' heat capacities. Initial temperatures of LaCrO₃ on 60 CeO₂ and YCrO₃ on 10 CeO₂ were 107° C. and 114° C., respectively, compared to 158° C. for the Control, which means that the new catalysts also had to overcome lower starting temperatures.

The relative performance of the other catalysts was more or less comparable to that of the Control.

The invention has been described with reference to various examples and embodiments, but is not limited thereto. Various modifications can be made without departing from the invention, the scope of which is limited only by the appended claims and their equivalents. Throughout the claims, use of “a” and other singular articles is not intended to proscribe the use of plural components. Thus, more than one PGM may be deposited onto a catalytically active support material; more than one support material may be utilized, and so forth. Also, use of the word “about” in relation to a range of values is intended to modify both the high and low values recited, and reflects the penumbra of variation associated with measurement, significant figures, and interchangeability, all as understood by a person having ordinary skill in the art to which this invention pertains.

What is claimed is:

1. A propellant decomposition catalyst, comprising:
a platinum group metal catalyst supported by a second catalyst selected from the group consisting of barium oxide, metal chromites, metal hafnates, metal zirconates other than calcium zirconate, and hydrates and mixtures thereof.

2. A catalyst as recited in claim 1, wherein the platinum group metal catalyst is selected from the group consisting of iridium, ruthenium, and mixtures and alloys thereof.

3. A catalyst as recited in claim 1, wherein the platinum group metal catalyst is present in amount of from about 15 to 30% by weight of the second catalyst.

4. A catalyst as recited in claim 1, wherein the second catalyst is porous, and the platinum group metal catalyst is deposited as discrete particles in the pores of the second catalyst.

5. A catalyst as recited in claim 1, wherein the second catalyst comprises barium hafnate or a hydrate thereof.

6. A catalyst as recited in claim 1, wherein the second catalyst comprises barium zirconate or a hydrate thereof.

7. A catalyst as recited in claim 1, wherein the second catalyst comprises yttrium chromite or a hydrate thereof.

8. A catalyst as recited in claim 1, wherein the second catalyst comprises a lanthanide chromite or a hydrate thereof.

9. A catalyst as recited in claim 1, wherein the lanthanide chromite is selected from the group consisting of lanthanum chromite, ytterbium chromite, erbium chromite, neodymium chromite, and mixtures thereof.

10. A catalyst as recited in claim 1, further comprising a source of, and/or a sink for, oxygen radicals or ions.

11. A catalyst as recited in claim 10, wherein the source and/or sink comprises cerium oxide.

12. A catalyst as recited in claim 1, wherein the platinum group metal catalyst is supported by a mixture of cerium oxide and yttrium chromite or a hydrate thereof.

13. A catalyst as recited in claim 1, wherein the platinum group metal catalyst is supported by a mixture of cerium oxide and lanthanum chromite or a hydrate thereof.

14. A catalyst as recited in claim 1, wherein the second catalyst has a surface area of from about 0.1 to 1000 m²/g prior to supporting the platinum group metal catalyst.

15. A catalyst as recited in claim 1, wherein the second catalyst has a surface area of from about 0.1 to 105 m²/g prior to supporting the platinum group metal catalyst.

16. A catalyst as recited in claim 1, wherein the second catalyst has a surface area of at least about 3 m²/g prior to supporting the platinum group metal catalyst.

17. A catalyst as recited in claim 1, wherein the second catalyst has a surface area of at least about 10 m²/g prior to supporting the platinum group metal catalyst.

18. A catalyst as recited in claim 1, wherein the second catalyst comprises porous granules.

19. A catalyst as recited in claim 1, wherein the second catalyst comprises a powder.

20. A catalyst as recited in claim 1, wherein the second catalyst comprises a porous monolith.

21. A catalyst as recited in claim 1, loaded into a monopropellant thrust chamber.

22. A method of decomposing a propellant, comprising:
passing a propellant over a decomposition catalyst as recited in claim 1.

23. A method of decomposing a propellant, comprising:
passing a propellant having an adiabatic flame temperature, T₁, over a platinum group metal catalyst supported by a second catalyst; and
sustaining propellant decomposition as the platinum group metal catalyst is eroded away during use by passing a propellant over the second catalyst;
wherein the second catalyst has a melting point higher than T₁, and is selected from the group consisting of metal chromites, metal hafnates, metal zirconates other than calcium zirconate, barium oxide, and hydrates and mixtures thereof.

24. A method as recited in claim 23, wherein the platinum group metal catalyst is selected from the group consisting of iridium, ruthenium, and mixtures and alloys thereof.

25. A method as recited in claim 23, wherein the second catalyst is porous, and the platinum group metal catalyst is deposited as discrete particles in the pores of the second catalyst.

26. A method as recited in claim 23, wherein the second catalyst comprises barium hafnate or a hydrate thereof.

27. A method as recited in claim 23, wherein the second catalyst comprises barium zirconate or a hydrate thereof.

28. A method as recited in claim 23, wherein the second catalyst comprises yttrium chromite or a hydrate thereof.

29. A method as recited in claim 23, wherein the second catalyst comprises a lanthanide chromite or a hydrate thereof.

30. A method as recited in claim 23, wherein the lanthanide chromite is selected from the group consisting of lanthanum chromite, ytterbium chromite, erbium chromite, neodymium chromite, and mixtures thereof.

31. A method as recited in claim 23, wherein the second catalyst is admixed with cerium oxide.

32. A method as recited in claim 31, wherein the second catalyst comprises yttrium chromite or a hydrate thereof.

33. A method as recited in claim 31, wherein the second catalyst comprises lanthanum chromite or a hydrate thereof.

34. A method as recited in claim 23, wherein the propellant is a monopropellant.

35. A method as recited in claim 23, wherein the propellant is a bipropellant comprising a fuel component and an oxidizer.

36. A method as recited in claim 35, wherein propellant decomposition is initiated by decomposition of either or both of the fuel component and oxidizer.

37. A method as recited in claim 23, further comprising water.

38. A method as recited in claim 23, wherein the propellant comprises hydrazine or a hydrazine derivative.

39. A method as recited in claim 38, wherein the hydrazine derivative comprises monomethylhydrazine or unsymmetrical dimethylhydrazine.

40. A method as recited in claim 23, wherein the propellant comprises (a) a fuel component selected from the group of organic compounds consisting of hydrocarbons, alcohols, ketones, aldehydes, esters, ethers, carboxylic acids, and mixtures thereof; (b) an oxidizer; and (c) water.

41. A method as recited in claim 23, wherein the propellant comprises (a) a fuel component selected from the group consisting of hydroxyethylhydrazinium nitrate, diethylhydroxylammonium nitrate, triethanol amine nitrate, methanol, glycerol, tris(aminoethyl)amine trinitrate, glycine, and mixtures thereof; (b) an oxidizer; and (c) water.

42. A method as recited in claim 41, wherein the oxidizer is selected from the group consisting of hydroxylammonium nitrate, hydrazinium nitrate, ammonium dinitramide, hydrazinium nitroformate, ammonium nitrate, 1,4-diazobicyclo-(2,2,2)-octane nitrate, ethylamine nitrate, ethanolamine nitrate, hydroxylamine perchlorate, isopropylamine nitrate, methylamine nitrate, methyl hydrazine nitrate, propylene glycol nitrate, piperidine nitrate, triethylene glycol dinitrate, trimethylamine nitrate, ammonium dinitrimide, and mixtures thereof.

43. A method as recited in claim 41, wherein the oxidizer has a formula, AB, where A is selected from the group consisting of ammonium, hydroxylammonium, hydrazinium, piperidinium, n-alkyl ammonium, and quaternary ammonium, and B is selected from the group consisting of nitroformate, dinitrimide, and nitrate.

44. A method as recited in claim 23, wherein the propellant is selected from the group consisting of hydrazine, monomethyl hydrazine, unsymmetrical dimethylhydrazine, dimethylaminoethyl azide, competitive impulse non-carcinogenic hypergol (CINCH), mixtures of hydrazinium nitrate and water, mixtures of hydrazine and hydrazinium nitrate, nitrous oxide, mixtures of nitrous oxide and one or more fuel components, and mixtures of propylene glycol dinitrate, 2-nitrodiphenylamine, and dibutyl sebacate (Otto Fuel II).

45. A method of decomposing a propellant, comprising:
passing a propellant having an adiabatic flame temperature, T₁, over a catalyst having a melting point higher than T, said catalyst selected from the group consisting of metal chromites, metal hafnates, and hydrates and mixtures thereof.

46. A method as recited in claim 45, wherein the catalyst is admixed with cerium oxide.

47. A method as recited in claim 46, wherein the catalyst comprises yttrium chromite or a hydrate thereof.

48. A method as recited in claim 46, wherein the catalyst comprises lanthanum chromite or a hydrate thereof.

49. A method of sustaining propellant decomposition, comprising:
passing a propellant having an adiabatic flame temperature, T₁, over a catalyst comprising (a) a catalytic material having a melting point higher than T₁, selected from the group consisting of metal chromites, metal hafnates, and hydrates and mixtures thereof, or (b) a platinum group metal catalyst supported by a second catalyst selected from the group consisting of barium oxide, metal chromites, metal hafnates, metal zirconates other than calcium zirconate, and hydrates and mixtures thereof.

50. A reaction engine for use with a propellant, comprising:
a reaction chamber provided with a catalyst bed comprising (a) a catalytic material selected from the group consisting of metal chromites, metal hafnates, and hydrates and mixtures thereof, or (b) a platinum group metal catalyst supported by a second catalyst selected from the group consisting of barium oxide, metal chromites, metal hafnates, metal zirconates other than calcium zirconate, and hydrates and mixtures thereof.
